(19) United States
(12) Patent Application Publication
(10) Pub. No.: US 2002/0002597 A1
(43) Pub. Date: Jan. 3, 2002

(54) Systems and methods for producing reward advertising and distributing by click-through incentives

(76) Inventor: Calvin Morrell JR., Irvine, CA (US)

Correspondence Address: OPPENHEIMER WOLFF & DONNELLY LLP, 38TH FLOOR, 2029 CENTURY PARK EAST, LOS ANGELES, CA, 90067-3024, US

(21) Appl. No.: 09/896,419

(22) Filed: Jun. 29, 2001

Related U.S. Application Data
(60) Provisional application No. 60/214,953, filed on Jun. 29, 2000.

(51) Int. Cl. G06F 15/16; G06F 17/60

(52) U.S. Cl. 709/218; 705/77

(57) ABSTRACT

Systems and methods are disclosed for harnessing a significant volume of unique users to a host website, as through a registration process, to become a valuable asset to other online retailers (e-tailers) who desire to place reward advertisements or icons on the host website that permit users to click through directly to the e-tailer's website from the host site. Any reward offered by the e-tailer, a manufacturer of goods sold by the e-tailer, or another source, may be passed through to the users, in addition to the host site. This is accomplished by tracking click-through traffic generated by the high-incentive Internet ads and distributing the resultant rewards through specialized software. The user base will grow, retailer demand for access to that user base will grow, and the host site may also benefit by charging a membership fee to its users or fees to retailers using the service.

### BACKGROUND OF THE INVENTION

1. Field of the Invention

This invention relates to the World Wide Web and to incentive-based advertisement and sales systems by online retailers (e-tailers) thereon. More particularly, the invention relates to systems and methods for distributing advertising fees and purchase incentives, or portions thereof, directly to the advertisement recipients and customers.

2. General Background and State of the Art

The Internet provides a new medium in which to view, appreciate and utilize various forms of entertainment, information, shopping, and a variety of other interactive services to millions of users around the world. One way to finance such services on the Internet is through advertisement. Therefore, much attention has been focused on providing advertising through the Internet.

A popular method for providing Internet advertisement has been in the form of banner ads. By selling a portion of valuable space on a web page to accommodate banner ads, a web page content provider can finance and support the activities and content to which the remainder of the web page is devoted. Banner ads are typically displayed across the top or bottom of a web page and often include a stream of information designed to entice the web page visitor. When the web page visitor selects such a banner advertisement, by clicking through the banner with a mouse or other computerized pointing device or peripheral indicator, an HTTP message is generated by the visitor's web browser using the information encapsulated in association with the selected banner ad. The HTTP message causes the visitor's web browser to send a request to access a different Internet object or website with a predefined URL, or website address. An example of a different website would be the banner ad advertiser's home page. In other words, when a web page visitor clicks a banner ad, he or she “clicks through” to, or is re-directed to, a new website that was the subject of the banner ad.

Website content providers utilize various methods for payment of advertising fees. One method is a flat-rate base fee payment for web page space utilized by the banner ad. The amount of a base payment fee may be determined, for example, according to the worth of the banner-ad space to the web page owner, as that space must necessarily be forfeited by the web page owner for display of the advertiser's banner ad. Assessing the amount of value lost by forfeiting that space, which the web page owner is then unable to use for displaying his own content, helps determine a price for that space. The amount of a base fee payment might also be determined according to the worth of the banner advertisement to the advertiser. In essence, setting a base fee payment for banner ad space is similar to renting a portion of a building, such as a single unit or apartment.

Incentive-based advertising fee payment methods are also known and used in the art. For example, a retailer who sponsors a banner ad on a host web page may monitor the traffic to its own website that originates from the banner ad. In this manner, the retailer can track and measure the effectiveness of its banner advertisements, and pay the host website accordingly. In some cases, these payments may be conditional upon the user completing a designated transaction, such as making a purchase, at the website advertised in the banner ad. In these cases, payment is a proportional reward to the banner ad host site.

Typically, these base fees and/or incentive-based advertising fee payments are retained by the web host site in consideration for the use of its assets, which are its web page space and visitors. Web host site retention of incentive payments encourages the sale of web page space for display of banner ads. However, it does not encourage visitors to pay attention to banner ads or to utilize them in a way that will result in a transaction at the advertising retailer's website.

Accordingly, it is an object of the invention to provide website host and Internet users with retailer rewards, including but not limited to base fee payments, incentive-based advertising payments and/or manufacturer rebates, for example, for utilizing retailer advertisements and to increase the advertising value to retailers. It is a further object of the invention to provide a valuable customer base to retailers through creation of an on-line environment of registered Internet users having a vested interest in becoming the targets of retailer advertising in order to obtain the advertisers' inherent incentive value.

### SUMMARY OF THE INVENTION

These and other objectives are achieved by the present invention which, in a broad aspect, provides a large volume of Internet users that may be effectively targeted by on-line advertisements. The large user base is established and sustained through reward-based systems wherein users are incited to acknowledge and respond to advertisements. Prices of goods or services are reduced, and/or visitation to an advertised website is rewarded, through the incentives, of benefit to the users. Similarly, traffic to retailers who utilize on-line advertising is driven higher, of benefit to retailers. Furthermore, a host website that both displays the advertisements and generates the user rewards benefits through its access to the large user base in combination with collected rewards.

A large volume of visitors to a website can be a valuable asset to other on-line retailers who desire to place advertisements or icons on that website. The retailers generally offer a “reward” program to the host website, which may be a percentage of each sale by the retailer that originates from the host website through an advertisement or icon, for example. In contrast to the typical practice of a host website retaining the entirety of the reward, the present invention seeks to pass at least a portion of the reward through to the user. This not only increases the value of the advertisement to the host website and retailer, but the resultant user base will grow, to the benefit of both the host and retailer, retailer demand for access to the expanding host website will grow, and the host website will encounter similar functional and economic benefit further through its ability to charge membership fees to its expanding base of users.

These and other objects, features, and advantages of the present invention will be apparent to those skilled in the art from the following detailed description of exemplary embodiments which make reference to the following illustrative Figures.

### BRIEF DESCRIPTION OF THE DRAWINGS

FIG. 1 is a flow chart illustrating a typical prior art Internet reward payment scenario.

FIG. 2 is a flow chart of an embodiment of the present invention detailing an exemplary Internet reward advertising and distribution system and illustrating the features thereof.

FIG. 3 is a flow chart illustrating an additional exemplary embodiment of one form of a payment disbursement model according to an alternative embodiment of the present invention.

FIG. 4 is a flow chart detailing an additional exemplary embodiment of the present invention and illustrating the advertising payment determination logic thereof.

FIG. 5 illustrates a third additional exemplary embodiment of the present invention.

### DETAILED DESCRIPTION OF THE PREFERRED EMBODIMENTS

The systems and methods of the present invention enable Internet users 109 at a user site to visit a website, denoted a host site 105, in order to access advertisements 107 (ads) such as click-through banner advertisements displayed thereon. The ads 107, like their prior art predecessors, contain material designed to promote third-party interests, such as goods for sale by a retailer or information for dissemination by a clearinghouse. In contrast to the present invention, however, prior art Internet advertising systems, as illustrated in FIG. 1, generally enable a retailer website 101 to make incentive-based advertising fee payments 103 to the host site 105 in return for the host site's service of displaying ad 107. Typically, as shown in the art, the retailer website 101 makes the incentive-based advertising fee payments 103 to a host site 105 based upon the number of users 109 directed to retailer's website 101 through an ad 107 by tracking the variations 111, as the click-through traffic to its retailer website 101. The more click-through traffic to a retailer's website 101 generated at host site 105, therefore, the more rewards (incentive-based advertising fee payments 103 and/or base fee payments 113) host site 105 will receive from retailer website 101.

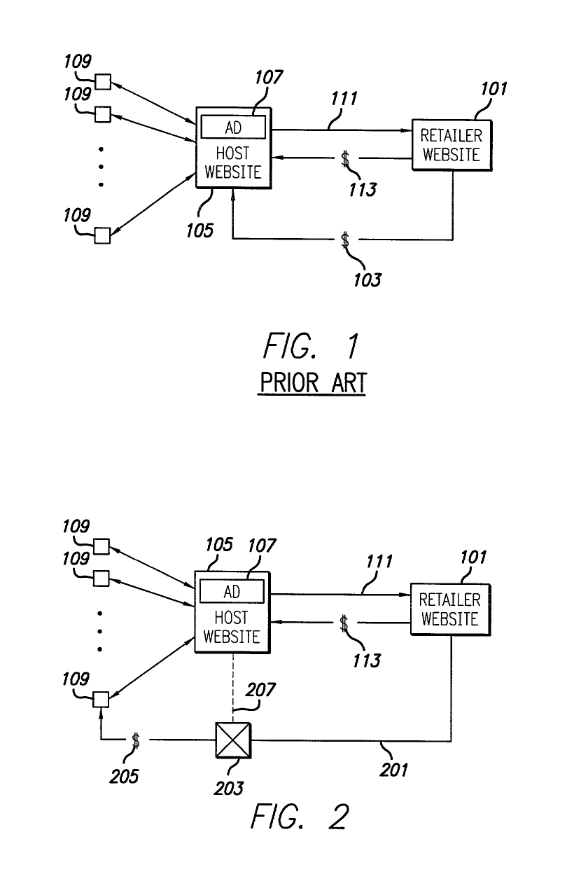

In contrast to the prior art, the present invention employs a sophisticated payment disbursement model 203 wherein the users 109 receive at least a portion if not all of any reward 205. As shown in FIG. 2, an embodiment of the present invention enables the retailer website 101 to track click-through traffic 111 from the banner ad 107, sending the tracking information 201 to a payment disbursement model 203, and to determine rewards 205 to be made payable to the users 109. These rewards 205 are made directly to the users 109, while host site 105 may continue to receive independent rewards, such as a base fee 113 from retailer website 101 in exchange for displaying an ad 107. An alternative tracking method involves host site 105 tracking click-through traffic 111 and sending the tracking information 207 to the payment disbursement model 203.

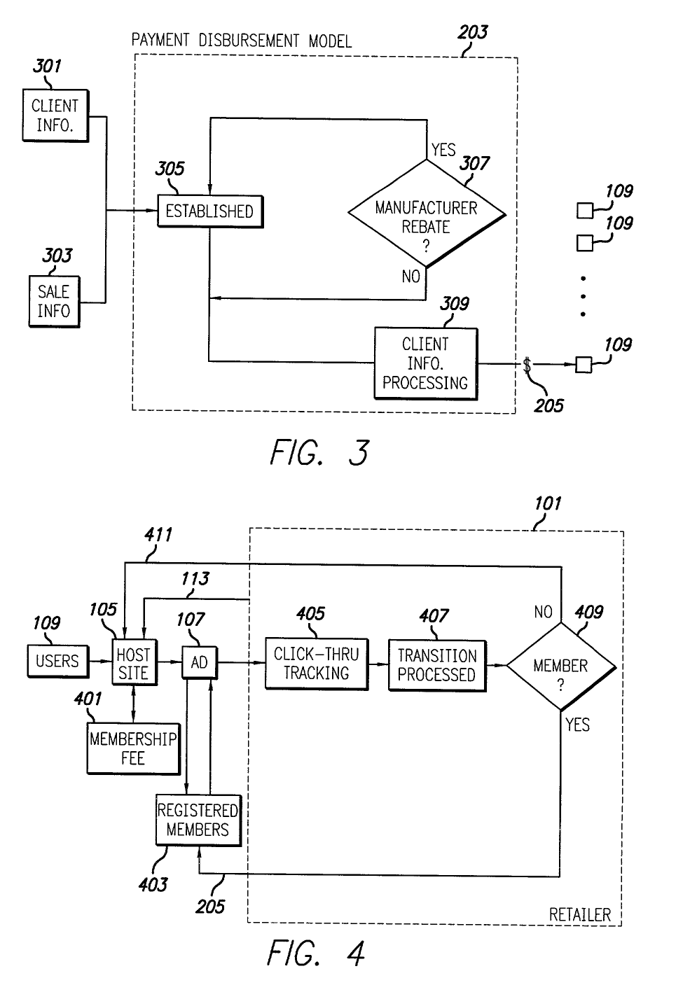

Logic for an exemplary payment disbursement model (model) 203 in accordance with the teachings of the present invention is detailed in the exemplary flow chart of FIG. 3. Various inputs are received by model 203 and may include registration information, such as client information 301 and sale information 303, among other types of information. Client information 301 may contain data related to, but not limited to, a user's identify, general profile information, preferred payment method information or any other information of interest. Sale information 303 may contain a variety of sales data including, but not limited to, data related to the goods or services involved in sales transaction, a dollar amount descriptive of the transaction, manufacturers associated with the goods or services of the sale, or additional information relevant to the transaction. This information is considered in step 305, which establishes an initial amount of the reward to be paid to user 109. The amount established in step 305 may depend on a variety of factors, in but not limited to percentage of the total sale or frequency of the particular user 109 as a customer. At step 307, it is determined whether an additional reward, such as a manufacturer rebate 307, is associated with the goods or services involved in the transaction. The reward 305 is adjusted by the amount of the additional rebate 307 in order to provide or maintain the reward click-through character of the ad. The final adjusted reward amount 205 is then considered for payment to user 109 in step 309. Factors of consideration in step 309 include, but are not limited to, user's 109 personal information such as preferred payment method. Reward payment 205 is then made to user 109. It will be apparent to one skilled in the art that various payment disbursement models 203 may be employed in accordance with the present invention, and may consider various client, sales, manufacturer, service provider, and other types of information in determining the amount and method of payment of the reward 205 to user 109.

An additional embodiment of the present invention is illustrated by the flow chart of FIG. 4. In this exemplary embodiment, when user 109 connects to host site 105, an opportunity is provided for user 109 to register and become a registered member 403. For example, user 109 may be required to pay a full membership fee 401 to host site 105, after which user 109 becomes part of an established group of registered members 403. Ads 107 are purchased by the retailer 101 (for example, by base fee payment 113) and are displayed by retailer website 101 on host site 105. Ads 107 may be accessed by any or all users 109, including those users 109 who are registered members 403. When an ad 107 is accessed, the retailer website 101 tracks the resultant incoming traffic at step 405. This tracking may include, but is not limited to, gathering information related to a user's registration status. It is also contemplated to be within the scope of the invention that the tracking 405 may be accomplished by the host site 105, and the tracking data subsequently delivered to the retailer website 101 in any of a variety of possible formats.

If a sale or other transaction is generated at 407 as a result of the click-through from the ad 107 on the host site 105, it is determined whether user 109 is a registered member at step 409. If user 109 is a registered member, a reward payment 205 is made directly to user 109. Additionally, a reward 205 may be paid to the host site 105, or to other designated recipients. Thus, for example a reward may be paid to the registered member, one reward may be spilt between the registered member and the host site or different types of rewards may paid to the registered member and the host site.

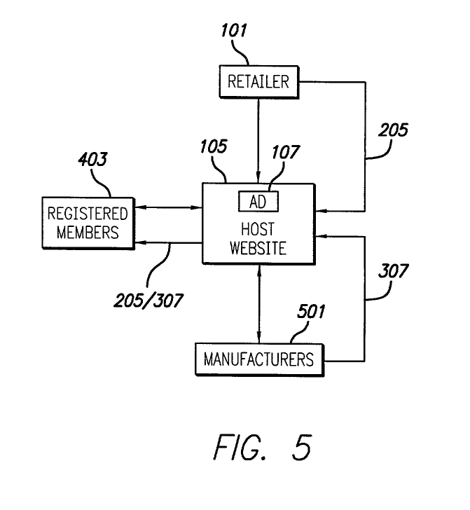

An additional embodiment of the present invention is illustrated by the flow chart of FIG. 5. In this embodiment, a host site 105 enters into agreements with manufacturers or providers 501 and retailers 101 who provide the goods or services produced by manufacturers or providers 501. Registered members 403 may access participating retailers 101 through ads 107 and placed on the host site 105. Upon completion of a sale or other qualifying transaction, the participating retailers 101 recognize registered members' 403 origination, or click-through, from the host site 105 and pay a reward 205 to the host site 105 to compensate for the transaction generated from the click-through. Likewise, the participating manufacturer or provider 501 recognizes the retailer's 101 sale or other transaction and pays a rebate 307 to the host site 105 to compensate the host site 105 for the sale generated from the affiliation. The resultant rewards are directed to registered member 403 in part or in whole as a credit, cash payment, or other form of incentive.

Host site 105 may credit the rewards 205/307 to the consumer through specialized, automated accounting software. This software may require placing a code on user's 109 computer in order to track user's 109 personalized account with originating host site 105. The placement of software on user's 109 computer may be incorporated as part of the registration process. If desired, user 109 may be provided with access to their secure personal account on the host website 105 by logging in with a special password or other security feature. If there is a positive balance in user's 109 account with host site 105, user 109 may request the balance be paid to it via check or, alternatively, may elect to use the balance to pay for membership fees to host site 105 or to pay for future goods or services from the participating retailer sites 101. Use of a positive balance toward future purchases may require additional accounting or crediting software between host site 105 and participating retailer sites 101. Alternatively, payments or application of credits toward purchases may be accomplished through direct communication with the host 105 and without the implementation of additional software.

In accordance with the teachings of the present invention, the creation of a group of registered members 403 with a host site 105 in combination with agreements between host site 105 and various retailers 101 and manufacturers or providers 501 creates a novel marketplace in which consumers, manufacturers, retailers, and subscription originators all benefit in unique ways. For example, manufacturers 501 and retailers 101 need not spend money for new advertising because the reward ads of the present invention retain their attractive utility. Business increases, and users directly benefit from their transactions.

The foregoing descriptions of exemplary embodiments of the present invention have been presented for the purposes of illustration, description and enablement. They are not intended to be exhaustive or to limit the present invention to the precise forms illustrated. Many modifications and variations of the present invention are possible within the scope of the above teachings. For example, qualifying transactions generating reward payments from retailers or manufacturers are not limited to goods and may include services or a simple contribution of information by the user 109, such as, for example, the completion of a survey or other data collection form. Also, the host site 105 may include additional information related to the collection of its group of registered members 403. For example, the host site 105 may contain shopping categories that the users 109 may customize to function as their start up screens to the host site 105. Further, banner ads 107 are not the only means by which users may access a retailer's website 101. Icons, links, or other connecting means may be utilized within the scope of the present invention to replace or substitute for “ads” 107. The present invention also is not limited to use in connection with sales and advertising across the Internet. Rather, the present invention may be used for a wide variety of sales and incentive programs across any available computer or communications networks.

Additionally, the term “retailer” may be used, but is not limited, to describe online retailers who offer goods for sale at a website accessible via the Internet or World Wide Web. It is also anticipated to be within the scope of the invention that retailers may include any provider of goods, services, or information, whether offered for sale or not. Likewise, “rewards” may include, but are not necessarily limited to, incentive-based payments calculated as a percentage of sales originated from a host website, or flat-fee based fee payments calculated according to the results of a user clicking through from a host website to a retailer website or manufacture coupons or rebates.

It is intended that the scope of the present invention be limited not by this detailed description, but only by the claims appended hereto.

While the specification describes particular embodiments of the present invention, those of ordinary skill can devise variations of the present invention without departing from the inventive concept.

What is claimed is:

1. A method for generating Internet reward advertising to at least one user that may be accessed by a retailer, the method comprising:
a host website providing the user access to a host website having a retailer advertisement functionally linked to a retailer website;
optionally the host website receiving a payment from the retailer for hosting the retailer advertisement;
the host website or retailer website or host website and retailer website directing a reward to the user upon the user completing a designated transaction at the retailer website, optionally, the retailer website directing a reward to the host website.

2. The method of claim 1, wherein the payment from the retailer to the host website is a base fee payment, an incentive-based advertising fee payment or a combination of a base fee payment and an incentive-based advertising fee payment.

3. The method of claim 2, wherein the incentive-based advertising fee payment is proportionate to the number of originations generated by users selecting the retailer ad on the host site, thereby accessing the retailer website.

4. The method of claim 1, wherein the amount of the reward to the user and the amount of the optional reward to the host website is calculated by a payment disbursement model.

5. A method for providing rewards to at least one user, the method comprising:
a host website providing a click-through retailer advertisement to a user;
a host website receiving payment from the retailer in exchange for posting the click-through retailer advertisement functionally linked to a retailer website; and
a host website directing the payment to the user upon the user clicking-through the retailer advertisement, and the user optionally completing a designated transaction at the retailer website.

6. A method for providing a reward to a user, the method comprising:
a host website collecting registration information from the user, whereby said user becomes a registered member;
optionally, a host website collecting a membership fee from the registered member;
optionally, the host website placing automated software on a data storage device utilized by the registered member;
a host website providing a user access to a host website having a retailer advertisement enabling the user to access the retailer website;
a retailer website providing a reward to a registered member completing a qualifying transaction at the retailer website; and
optionally, the host website or retailer website or both the host website and retailer website directing at least a portion of the reward to the registered member through the automated software.

7. The method of claim 6, wherein the registration information includes data descriptive of a method for the registered user to collect the reward.

8. Automated software executed on a user's client-side data processor device for providing rewards to the user.

9. The automated software of claim 8 wherein the reward includes at least one manufacturer-sponsored rebate or a retailer incentive-based advertising fee payment.

10. A payment disbursement model executed within a system for providing rewards for calculating the amount of a reward to be provided to a user on a host website or both a user and a host website.
